(19) United States
(12) Patent Application Publication
(10) Pub. No.: US 2017/0097996 A1
(43) Pub. Date: Apr. 6, 2017

(54) Systems and Methods for Privacy Preservation

(71) Applicant: Green Dot Corporation, Pasadena, CA (US)

(72) Inventors: David Gullett, Moorpark, CA (US); Calvin Park, Pasadena, CA (US); Adnan Masood, Pasadena, CA (US)

(21) Appl. No.: 14/876,032

(22) Filed: Oct. 6, 2015

(51) Int. Cl. G06F 17/30; G06Q 10/06

(52) U.S. Cl. CPC G06F 17/30864; G06Q 10/063

(57) ABSTRACT

Systems and methods for privacy preservation in accordance with embodiments of the invention are disclosed. In one embodiment, a method for storing data includes obtaining data using an account servicing server system, where the account servicing server system includes a processor, memory connected to the processor, a sensitive data database, and a query engine database, identifying sensitive data in the obtained data using the account servicing server system, where the sensitive data includes personally identifiable information, identifying non-sensitive data in the obtained data using the account servicing server system, storing the sensitive data in the sensitive data database using the account servicing server system, and storing the non-sensitive data in the query engine database using the account servicing server system.

### FIELD OF THE INVENTION

The present disclosure relates generally to financial services systems, and relates, more particularly, to preserving the privacy of information in financial systems.

### BACKGROUND

The financial services industry provides a plethora of financial services to consumers for managing their finances and engaging in financial transactions with retailers and service providers. Consumers may hold funds within many different types of accounts at many different types of financial institutions. Consumers may access the funds held in the accounts using many different types of cards, including credit cards, debit cards, gift cards, and other types of cards based on the particular type of account associated with the card. The cards may be issued from financial institutions, such as banks, credit unions, savings & loans, and brokerage institutions.

A payment processor is a company that handles transactions for one or more financial institutions. Many payment processors have connections to various card associations and supply authorization and settlement services to the financial institutions. Several payment processors facilitate the movement of funds between payment processors and financial institutions. Payment processors can verify aspects of proposed transactions. Once the payment processor has received confirmation or denial of the verification, the information can be relayed to the financial institution that can then complete or invalidate the payment transaction accordingly.

### SUMMARY OF THE INVENTION

Systems and methods for privacy preservation in accordance with embodiments of the invention are disclosed. In one embodiment, a method for storing data includes obtaining data using an account servicing server system, where the account servicing server system includes a processor, memory connected to the processor, a sensitive data database, and a query engine database, identifying sensitive data in the obtained data using the account servicing server system, where the sensitive data includes personally identifiable information, identifying non-sensitive data in the obtained data using the account servicing server system, storing the sensitive data in the sensitive data database using the account servicing server system, and storing the non-sensitive data in the query engine database using the account servicing server system.

In another embodiment of the invention, the sensitive data database includes a relational database management system.

In an additional embodiment of the invention, the query engine database includes a distributed computing platform.

In yet another additional embodiment of the invention, the obtained data includes transaction data including data selected from the group consisting of a transaction identifier, the amount of the transaction, the date of the transaction, the time of the transaction, the location at which the transaction was initiated, the payor account for the transaction, and the payee account for the transaction.

In still another additional embodiment of the invention, the personally identifiable information in the transaction data is selected from the group consisting of the payor account for the transaction and the payee account for the transaction.

In yet still another additional embodiment of the invention, the obtained data includes account data including data selected from the group consisting of reload activity, balance activity, and location data, consumer account profile data, demographic data, employment information, credit status, income data, and mailing address data.

In yet another embodiment of the invention, the personally identifiable information in the account data is selected from the group consisting of the consumer account profile data, the employment information, and the mailing address data.

In still another embodiment of the invention, the obtained data is obtained from a point of sale terminal located at a retailer.

In yet still another embodiment of the invention, the obtained data includes a set of attribute-value pairs formatted using the extensible business markup language and the sensitive data is identified based on the attributes present in the obtained data.

In yet another additional embodiment of the invention, the obtained data includes a set of values and the sensitive data is identified based identifying known patterns in the set of values.

Still another embodiment of the invention includes an account servicing server system, including a processor, memory connected to the processor and storing an account servicing application, a sensitive data database, and a query engine database, wherein the account servicing application directs the processor to obtain data, identifying sensitive data in the obtained data, where the sensitive data includes personally identifiable information, identifying non-sensitive data in the obtained data, storing the sensitive data in the sensitive data database, and storing the non-sensitive data in the query engine database.

In yet another additional embodiment of the invention, the sensitive data database includes a relational database management system.

In still another additional embodiment of the invention, the query engine database includes a distributed computing platform.

In yet still another additional embodiment of the invention, the obtained data includes transaction data including data selected from the group consisting of a transaction identifier, the amount of the transaction, the date of the transaction, the time of the transaction, the location at which the transaction was initiated, the payor account for the transaction, and the payee account for the transaction.

In yet another embodiment of the invention, the personally identifiable information in the transaction data is selected from the group consisting of the payor account for the transaction and the payee account for the transaction.

In still another embodiment of the invention, the obtained data includes account data including data selected from the group consisting of reload activity, balance activity, and location data, consumer account profile data, demographic data, employment information, credit status, income data, and mailing address data.

In yet still another embodiment of the invention, the personally identifiable information in the account data is selected from the group consisting of the consumer account profile data, the employment information, and the mailing address data.

In yet another additional embodiment of the invention, the obtained data is obtained from a point of sale terminal located at a retailer.

In still another additional embodiment of the invention, the obtained data includes a set of attribute-value pairs formatted using the extensible business markup language and the sensitive data is identified based on the attributes present in the obtained data.

In yet still another additional embodiment of the invention, the obtained data includes a set of values and the sensitive data is identified based identifying known patterns in the set of values.

### BRIEF DESCRIPTION OF THE DRAWINGS

FIG. 1 is a conceptual illustration of an account servicing system in accordance with an embodiment of the invention.

FIG. 2 is a conceptual illustration of an account servicing server system in accordance with an embodiment of the invention.

FIG. 3A is a flow chart illustrating a process for storing data in accordance with an embodiment of the invention.

FIG. 3B is a conceptual illustration of a sensitive data database and a corresponding query engine database in accordance with an embodiment of the invention.

FIG. 4 is a flow chart illustrating a process for generating a query engine database in accordance with an embodiment of the invention.

FIG. 5 is a flow chart illustrating a process for providing result data using a query engine database in accordance with an embodiment of the invention.

FIG. 6 is a flow chart illustrating a process for providing sensitive data in accordance with an embodiment of the invention.

### DETAILED DESCRIPTION

Turning now to the drawings, systems and methods for privacy preservation in accordance with embodiments of the invention are disclosed. Prepaid accounts allow consumer accounts to easily have access to funds that have been deposited to their prepaid account without the overhead of a traditional financial institution. Funds can be loaded onto consumer accounts associated with the prepaid card (i.e. a prepaid card account) at a variety of participating locations, such as retailers. These funds can be loaded onto a prepaid card (i.e. deposited into the consumer account associated with the prepaid card) through various mechanisms, including direct deposit, check deposit, wire transfers, online deposits, cash deposits, and any other techniques as applicable to the requirements of specific embodiments of the invention. Consumers can then use the prepaid cards in a manner similar to traditional debit and/or credit cards to purchase products using the funds that have been loaded onto the account.

Account servicing systems in accordance with embodiments of the invention can generate a variety of data. In many embodiments, this data includes transaction data describing various attributes of a particular transaction. These transactions can be executed using any payment method including, but not limited to, cash, check, Automated Clearing House (ACH) transactions, debit cards, credit cards, and prepaid cards. The attributes and values that can be described in the transaction data are described in more detail below. Additionally, it should be noted that the sensitive data database and/or the query engine database are not limited to uses involving transaction data. Any other data present in the account servicing system, such as account data, can include sensitive data and non-sensitive data. The generated data can include sensitive data and non-sensitive data. Sensitive data can include personally identifiable information (PII) that can be used on its own or with other information to identify, contact, or locate a single person, or to identify an individual in context. PII can include, but is not limited to, names, addresses, email address, social security numbers (or any national identification number), passport number, vehicle identification data, driver's license numbers, prepaid (or any other) card numbers, date of birth, location of birth, telephone numbers, and user names. Sensitive data can be indicated in a variety of ways within the transaction data, such as by tagging the data using tag metadata (such as XML markup), by encrypting the sensitive data, by using pattern matching to identify sensitive data, and any other technique as appropriate to the requirements to specific applications of embodiments of the invention. Account servicing systems use a variety of techniques to secure PII included in the received transaction data. Many of these techniques are defines using a variety of standards such as the Payment Card Industry Data Security Standard (PCI DSS) mandated by the Payment Card Industry Security Standards Council of Wakefield, Massachusetts. These techniques can include, but are not limited to, using secure networks to connect systems storing sensitive data, encrypting transmissions of the sensitive data, restricting access (both physical and electronic) to sensitive data to a select group of users, each having a unique user name, and logging all access to sensitive data.

In addition to generating data, account servicing systems can store and provide access to the generated data. However, in order to conform to a variety of security standards, account servicing systems can employ a variety of techniques to protect the sensitive data while providing broader access to the non-sensitive data. In many embodiments, account servicing server systems obtain a variety of data and store the obtained data using both a sensitive data database and a query engine database. The sensitive data database can be secured and have tightly controlled access per any of a variety of security standards while the query engine database is more generally accessible. The data, including the sensitive data, can be stored in the sensitive data database, while the non-sensitive data (i.e. the portion of the data remaining after having the sensitive data removed) can be stored in the query engine database. The query engine database can then be utilized to obtain and process the non-sensitive data by a variety of users and/or devices. Index data can be utilized to join (or otherwise locate) corresponding rows of data in each of the sensitive data database and query engine database when requested with sufficient privileges to access the sensitive data. However, it should be noted that a variety of embodiments include storing the sensitive data only in the sensitive data database and the non-sensitive data only in the query engine database. The index data can then be used to reconstruct the original data using the data stored in each of the databases.

In several embodiments, the transaction data is associated with transactions to be executed against one or more consumer accounts and/or prepaid cards. In accordance with embodiments of the invention, account servicing server systems can provide a dynamic payment routing service to consumer accounts and to users of prepaid cards. In a variety of embodiments, one or more funding accounts can be associated with a consumer account. The consumer account can also include a variety of routing rules describing how transactions should be fulfilled (i.e. how the requested payment amount is to be provided) from the account balance associated with the consumer account and/or the funding accounts. In several embodiments, account servicing server systems can track funds available in each funding account and determine the appropriate funding account to use to fulfill a transaction accordingly. Furthermore, the routing of payments can be utilized in foreign transactions (e.g. those occurring in foreign countries to the home country of the consumer account and/or those transactions utilizing a currency that is not associated with the consumer account) in several embodiments of the invention. Metadata describing the funding sources can be included in the consumer account and utilized to determine which funding source(s) should be utilized for a particular transaction. Funding sources can include, but are not limited to, debit card accounts, credit card accounts, prepaid cards, closed-loop accounts, checking accounts, savings accounts, and any other account capable of holding and providing funds as appropriate to the requirements of specific applications of embodiments of the invention. In many embodiments, the funding accounts are serviced by third-party funding sources (i.e. provided by funding source systems and/or financial institution systems) that are separate and distinct from the account servicing server system servicing the consumer account. A variety of routing rules can be utilized as appropriate to the requirements of specific applications of embodiments of the invention as described in further detail herein. Notifications can be provided to a consumer account, such as those displayed on client devices, and contain information related to which funding sources have been utilized to fulfill particular transactions. Systems and methods for dynamic account routing that can be utilized in accordance with embodiments of the invention are described in U.S. patent application Ser. No. 14/806,459, titled “Systems and Methods for Dynamic Account Routing” and filed Jul. 22, 2015, the disclosure of which is hereby incorporated by reference in its entirety.

Account servicing systems in accordance with a variety of embodiments of the invention include account servicing server systems that can communicate with consumer systems and isolate those communications from payment processor systems and/or financial institution systems. Consumer systems include point of sale systems, client devices, retailer systems, and any other system that can be utilized to obtain and/or display data regarding a consumer account as appropriate to the requirements of specific applications of embodiments of the invention. Account servicing systems can abstract and isolate payment processor systems and/or financial institution systems from the account servicing server system utilizing a banking platform interface. The banking platform interface can allow an account servicing server system to seamlessly communicate with multiple payment processor systems and/or financial institution systems by translating internal command data to payment processor system (and/or financial institution system) command data. The banking platform interface allows for the dynamic routing of communication between consumer systems, account servicing server systems, and payment processor systems and/or financial institution systems. Additionally, the account servicing system can then automatically prepare (and/or translate) data provided as part of the services to command data that is utilized by payment processor systems to execute the requested services. In a variety of embodiments, a payment processor system identifies a consumer account using processor account identifier data. The same consumer account can also be identified by an account servicing server system using account identifier data. Using the banking platform interface, the account servicing server system can dynamically map account identifier data and processor account identifier data in order to identify particular consumer accounts. Systems and methods for providing banking platform interfaces that can be utilized in accordance with embodiments of the invention are described in U.S. patent application Ser. No. 14/718,811, titled “Systems and Methods for Banking Platform Isolation” and filed May 21, 2015. The disclosure of U.S. patent application Ser. No. 14/718,811 is hereby incorporated by reference in its entirety.

Additionally, a variety of data can be communicated within account servicing systems. Account servicing systems in accordance with embodiments of the invention can provide an abstraction and security service for transactions occurring via an Automated Clearing House (ACH) network. Consumer accounts can be provided by an account servicing server system, where the consumer accounts include profile data describing one or more accounts provided by third party financial institution systems. The account servicing server system can provide a specific routing number and ACH account number to a particular consumer account. These consumer account-specific numbers can be provided to third parties wishing to execute credit and/or debit transactions against the consumer account. In this way, the account servicing server system abstracts access to the financial accounts as the ACH routing information for the financial accounts is not disclosed to the third parties. The account servicing server system can then obtain debit and/or credit transactions using the consumer account-specific routing information. A variety of routing rules can then be applied to authenticate that the requested transaction is being provided by an authorized third party, authorized to be performed by the requesting third party, is within the authorized limits for transactions from that party, and/or any other authorization techniques as required by specific applications of embodiments of the invention. The routing rules can also identify specific financial accounts for particular transactions and route the debit and/or credit transactions to one or more of the linked financial accounts. Additionally, a variety of notifications can be provided to a consumer account, such as those displayed on client devices, and contain information related to credit and/or debit transactions targeted toward the consumer account and the actions taken against the financial institution accounts in response to the transactions. Systems and methods for providing transaction routing services that can be utilized in accordance with embodiments of the invention are described in U.S. patent application Ser. No. 14/832,678, titled “Systems and Methods for Transaction Routing” and filed Aug. 21, 2015, the disclosure of which is hereby incorporated by reference in its entirety.

It should be noted that any of a variety of consumer accounts in accordance with embodiments of the invention are not associated with a prepaid card. These prepaid cards (and/or consumer accounts) can be known as routing cards (and/or routing accounts) and allow consumer accounts to link a variety of funding sources to the routing cards and then utilize the routing cards as a single payment method to dynamically draw funds from the linked funding sources. Any reference to prepaid cards herein also includes utilizing routing cards to effect similar systems and/or processes.

Although the embodiments described herein are generally described in terms of transaction data and/or account data, similar processes can be applied to any data including PII or any other sensitive data. Accordingly, embodiments of the invention include those that utilize the systems and methods described herein to segregate the storage of sensitive data and non-sensitive data includes in any data obtained or processed within account servicing systems. This data can include user profile data, balance data, fee data, and any other data related to the prepaid card and/or the consumer account as appropriate to the requirements of specific applications of embodiments of the invention. Systems and processes for privacy preservation in accordance with embodiments of the invention are described in more detail below.

### Account Servicing Systems

Conducting financial transactions can involve communication between many different parties (e.g., banks, processors, credit issuers, regulators, consumers, etc . . . ) prior to funds being exchanged between a consumer and a retailer (i.e. between a consumer account and the retailer's account). For example, a consumer account may initiate a purchase at a point-of-sale terminal of a retailer. The retailer system may track certain information for the consumer account, including the items being purchased and the total purchase price and may send this information to a payment processor system. In turn, the payment processor system can communicate with a multitude of financial institution systems in order to process the transaction. Records of the transaction can be described using transaction data that can be provided to an account servicing server system. The transaction data can be processed and/or stored using an account servicing server system responsible for providing access to the sensitive data and non-sensitive data contained within the transaction data.

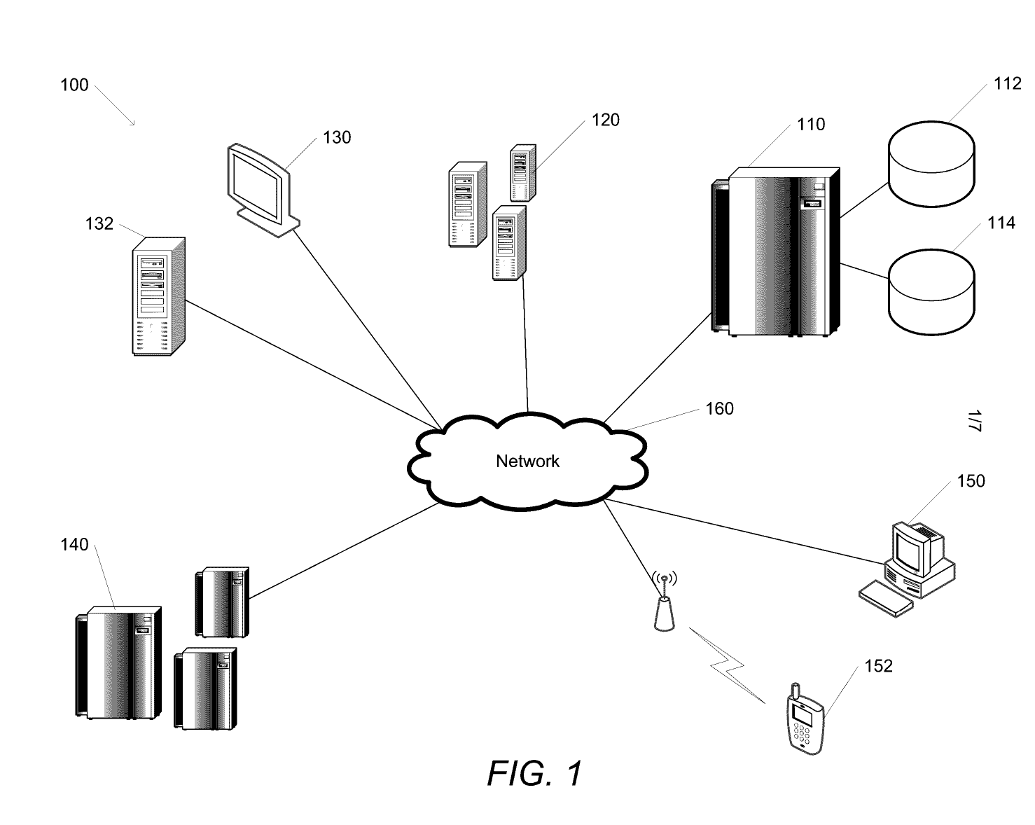

Turning now to FIG. 1, a conceptual illustration of an account servicing system in accordance with an embodiment of the invention is shown. The account servicing system 100 includes account servicing server system 110, payment processor systems 120, retailer systems such as point of sale terminals 130 and retailer server system 132, financial institution systems 140, and client devices including, but not limited to, personal computers 150 and mobile devices 152. The account servicing server system 110 includes a sensitive data database 112 and a query engine database 114. Sensitive data database 112 and query engine database 114 can be any device capable of storing data including relational databases, object-oriented databases, NoSQL databases, distributed computing platforms such as Apache Hadoop developed by the Apache Software Foundation of Forest Hill, Md., batch processing systems, data warehouses, and any other system configured to store data and provide access to that data as appropriate to the requirements of specific applications of embodiments of the invention. It should be noted that the sensitive data database 112 and the query engine database 114 can be implemented using a single computing device and/or distributed computing devices, communicating directly with the account servicing server system 110 and/or via a network connection, as appropriate to the requirements of specific applications of embodiments of the invention.

These systems can communicate through one or more networks 160. Network(s) 160 can include, but are not limited to, the Internet, a local area network, a wide area network, and networks that are shared privately between only a subset of the systems. For example, the payment processor 120 can communicate with the financial institution systems 140, retailer systems, and account servicing server system 110 via one or more private networks.

Account servicing server system 110 can provide front-end and back-end services for creating and managing consumer accounts via a number of account servicing processes as appropriate to the requirements of specific applications of embodiments of the invention. Account servicing server system 110 can obtain account data for a prepaid card and/or a variety of funding sources from a retailer system and/or from a client device. The account servicing server system 110 can assign the consumer account to a payment processor system 120 and/or financial institution system 140. A request that a permanent card (such as a prepaid card or a routing card) be issued to the account holder associated with the account by the payment processor system 120 and/or financial institution system 140 can also be made. The account servicing server system 110 can also communicate with financial institution systems 140 and/or the payment processor systems 120 to facilitate the execution of transactions between consumer accounts, funding sources, and retailer systems when the transaction involves the prepaid card. This can include storing a variety of data obtained from the payment processor systems 120, financial institution systems 140, and/or retailer systems and using the stored data to provide account servicing processes. In many embodiments, the account servicing server system 110 includes some or all of the aspects of the payment processor systems 120 and/or the financial institution systems 140. In a number of embodiments, the retailer systems host their own account servicing server system 110.

The account servicing server system 110 can also provide one or more interfaces for accessing account data, user profile data, balance data, transaction data, fee data, and any other data related to the prepaid card and/or the consumer account as appropriate to the requirements of specific applications of embodiments of the invention. When a transaction is executed (and/or requested to be executed), the account servicing server system 110 can obtain transaction data describing the transaction, including the amount to be debited as a result of the transaction and/or the status (i.e. approved, denied) of the transaction. In many embodiments, transaction data can be transmitted by a payment processor system 120 and/or a retailer system. The account servicing server system 110 can then store the received transaction data using the sensitive data database 112 and/or the query engine database 114. As described in more detail below, the sensitive data database 112 can be utilized to store the transaction data, including (or potentially limited to) the sensitive data, while the query engine database 114 can be utilized to store the non-sensitive data described in the transaction data. The account servicing server system 110 can provided controlled access to the sensitive data database 112 while providing more general access to the query engine database 114. Techniques for accessing data that can be utilized in accordance with embodiments of the invention are described in more detail below. In this way, any potential security breaches involving the query engine database 114 are unable to result in the loss of any sensitive data as the sensitive data is not present in the query engine database 114. For those requests having sufficient privileges to access the sensitive data, the sensitive data stored in the sensitive data database 112 can be matched to result data generated using the query engine database 114 to incorporate the sensitive data into the result data.

Retailer systems, such as point of sale terminal 130, can be used to purchase prepaid cards, load fund onto the prepaid cards, as well as process transactions that use a prepaid card associated with a consumer account to make purchases of products and/or services from the retailer. The point of sale terminal 130 can transmit transaction data describing requested transactions to the retailer server system 132 and/or the processor system 120. Similarly, the point of sale terminal can also provide account data. In many embodiments, the point of sale terminal 130 communicates directly with the account servicing server system 110. In a variety of embodiments, the retailer server system 132 obtains data from a number of point of sale terminals 130 and transmits the data to the payment processor system 120, financial institution system 140, and/or the account servicing server system 110. In many embodiments, the account servicing server system 110 stores data obtained from the retailer systems and/or associates the obtained data with particular consumer accounts.

Payment processor systems 120 can process transactions on behalf of financial institution 140, retailer systems, card issuers, and many other types of financial institutions. In many embodiments, prepaid cards serviced by the account servicing server system 110 are associated with a particular payment processor system 120. In a variety of embodiments, the payment processor system 120 issues the prepaid cards for a particular consumer account. Payment processor systems 120 provide a transaction interface that can be utilized to generate and/or process transaction data. The transaction data can be obtained from any system, including the retailer systems. The payment processor system 120 can process data in real-time, on a set schedule, and/or in batch as appropriate to the requirements of specific applications of embodiments of the invention. In a number of embodiments, the payment processor system 120 processes transactions for prepaid cards (or any other account) issued by (or otherwise associated with) the payment processor system 120. In a variety of embodiments, the payment processor system 120 provides a bill payment service between one or more consumer accounts. In a variety of embodiments, payment processor systems 120 provide one or more account servicing interfaces to communicate with the account servicing server system 110 and/or financial institution system 140. The account servicing interface can be utilized by the account servicing server system 110 to obtain and/or transmit data to and from the payment processor system 120. For example, if the payment processor system 120 needs additional information in order to process a transaction, that information can be requested and obtained from the account servicing server system 110 and/or the financial institution system 140. However, it should be noted that any processes that include communication between the payment processor system 120 and other systems within the account servicing system 100 can utilize the account servicing interface as appropriate to the requirements of specific embodiments of the invention.

Financial institution systems 140 include financial accounts for one or more entities. These financial accounts hold funds on behalf of the entities and can transfer the funds to retailer systems, payment processors, account servicing server systems, or any other system as appropriate to the requirements of specific applications of embodiments of the invention. In many embodiments, financial institution systems 140 incorporate some or all aspects of the payment processor systems 120. In this way, financial institution systems can issue, service, and/or approve transactions for consumer accounts related to prepaid cards.

Client devices can be used to manage account data associated with prepaid cards, purchase cards, add (e.g. reload) or remove funds from cards, purchase products from a retailer, request and/or accept loans, manage funding sources, view and configure routing rules, and any other transactions or operations as appropriate to the requirements of specific applications of embodiments of the invention. Additionally, client devices can be utilized to request data from account servicing server systems for processing and/or analysis. The account servicing server systems 110 can provide account data, balance data, transaction data, routing rule data, funding source data, and/or any other appropriate data to the client devices. The requested data can include non-sensitive data provided from a query engine database. In a variety of embodiments, permissions data describes particular access rights with respect to sensitive data available to the client device. Any data describing permissions to data, including user-based authorizations and device-based authorizations, can be utilized to access sensitive data as appropriate to the requirements of specific applications of embodiments of the invention. The permissions data can be utilized to grant access to some and/or all of the sensitive data stored in the sensitive data. In this way, granular security controls can be implemented on a per-account, per-transaction, and/or per-data class. If the requesting client device has sufficient permissions, the appropriate sensitive data can be included in the result data.

Although a specific architecture of an account servicing system in accordance with embodiments of the invention are discussed above, a variety of architectures, including client devices not specifically named and account servicing server systems that incorporate aspects of payment processor systems and/or financial institution systems, can be utilized in accordance with embodiments of the invention. Furthermore, it should be noted that any data created and/or transferred within the system can be provided by any system in any manner (i.e. via one or more application programming interfaces (APIs) web services, and/or file-based interfaces not specifically described herein) as appropriate to the requirements of specific applications of embodiments of the invention.

### Account Servicing Server Systems

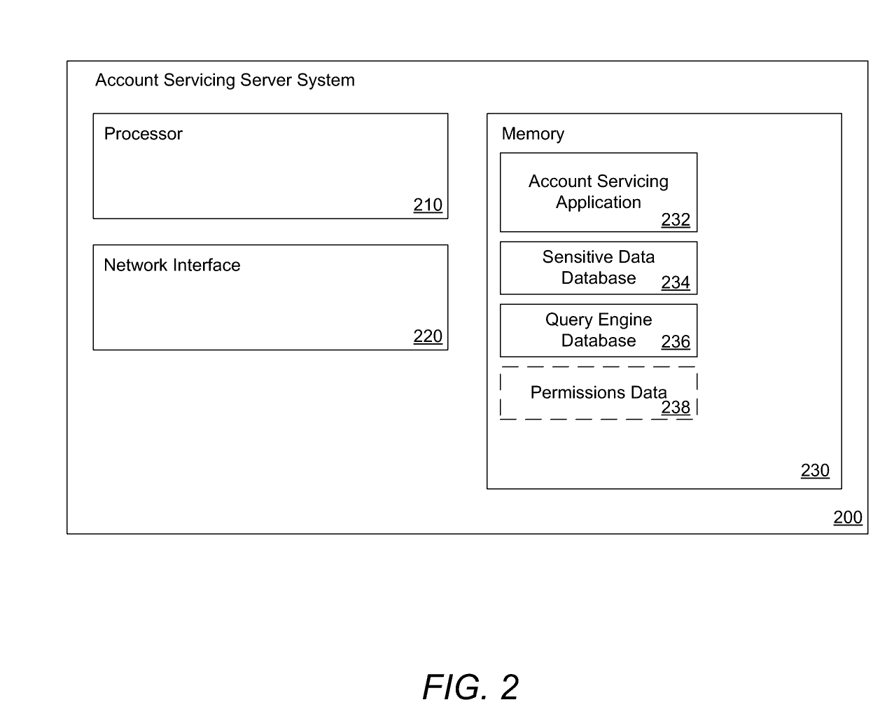

As described above, account servicing server systems can provide a variety of services for storing and providing data. An account servicing server system in accordance with an embodiment of the invention is conceptually illustrated in FIG. 2. The account servicing server system 200 includes a processor 210 in communication with a network interface 220 and a memory 230. The network interface 220 is capable of sending and receiving data over a network connection. In a number of embodiments, the network interface 220 is in communication with the memory 230. In several embodiments, memory 230 is any form of storage storing a variety of data, including, but not limited to, an account servicing application 232, a sensitive data database 234, a query engine database 236, and, in several embodiments, permissions data 238.

The account servicing application directs the processor 210 to perform a variety of account servicing processes. The account servicing processes include obtaining data having sensitive data and non-sensitive data and storing the data using a sensitive data database and a query engine database. The account servicing processes can also include obtaining queries for data. Account servicing processes can further include generating result data using the query engine database and, if sufficient permissions are associated with the obtained query, including sensitive data in the result data.

As described above, any of a variety of data can be stored using the account servicing processes. Several embodiments of the invention include obtaining and storing transaction data. Transaction data can include data describing a transaction including a transaction ID, the amount of the transaction, the date and/or time of the transaction, the location at which the transaction was initiated, the payor account for the transaction, the payee account for the transaction, and any other data relevant to the transaction as appropriate to the requirements of specific applications of embodiments of the invention. Many of these embodiments include storing account data. Account data can include data describing a consumer account including, but not limited to, reload activity, balance activity, and location data, consumer account profile data, demographic data, employment information, credit status, income, mailing address, and/or any other consumer account pertinent information.

Although a specific architecture for an account servicing server system in accordance with an embodiment of the invention is conceptually illustrated in FIG. 2, any of a variety of architectures, including those that store data or applications on disk or some other form of storage and are loaded into memory at runtime, can also be utilized. In a variety of embodiments, the memory 230 includes circuitry such as, but not limited to, memory cells constructed using transistors, that are configured to store instructions. Similarly, the processor 210 can include logic gates formed from transistors (or any other device) that dynamically perform actions based on the instructions stored in the memory. In several embodiments, the instructions are embodied in a configuration of logic gates within the processor to implement and/or perform actions described by the instructions. In this way, the systems and methods described herein can be performed utilizing both general-purpose computing hardware and by single-purpose devices. A variety of account servicing processes in accordance with embodiments of the invention are discussed further below.

### Storing Data

Account servicing processes in accordance with embodiments of the invention include obtaining a variety of data, such as transaction data and account data, having sensitive data and non-sensitive data and storing the data in a variety of databases. The obtained data can include a variety of attribute/value pairs. In several embodiments, the obtained data is formatted using the extensible markup language (XML) or the extensible business reporting language (XBRL). It should be noted that the obtained data can be encoded using any of a variety of techniques as appropriate to the requirements of specific applications of embodiments of the invention. In a number of embodiments, the obtained data is in a pre-defined format and only contains sets of values, where the corresponding attributes are known based on the format. The account servicing processes can further include identifying sensitive data within the obtained data and filtering the sensitive data from the non-sensitive data in the obtained data. A variety of processes for identifying and filtering sensitive data from the obtained data are described in more detail below. Once identified, the sensitive data (alone or along with the non-sensitive data) can be stored in the sensitive data database while the non-sensitive data is stored using the query engine database. In a variety of embodiments, one or more attributes in the obtained data can be utilized to match corresponding pieces of sensitive data and non-sensitive data. In several embodiments, one or more indexing values can be generated and assigned to corresponding pieces of sensitive and non-sensitive data.

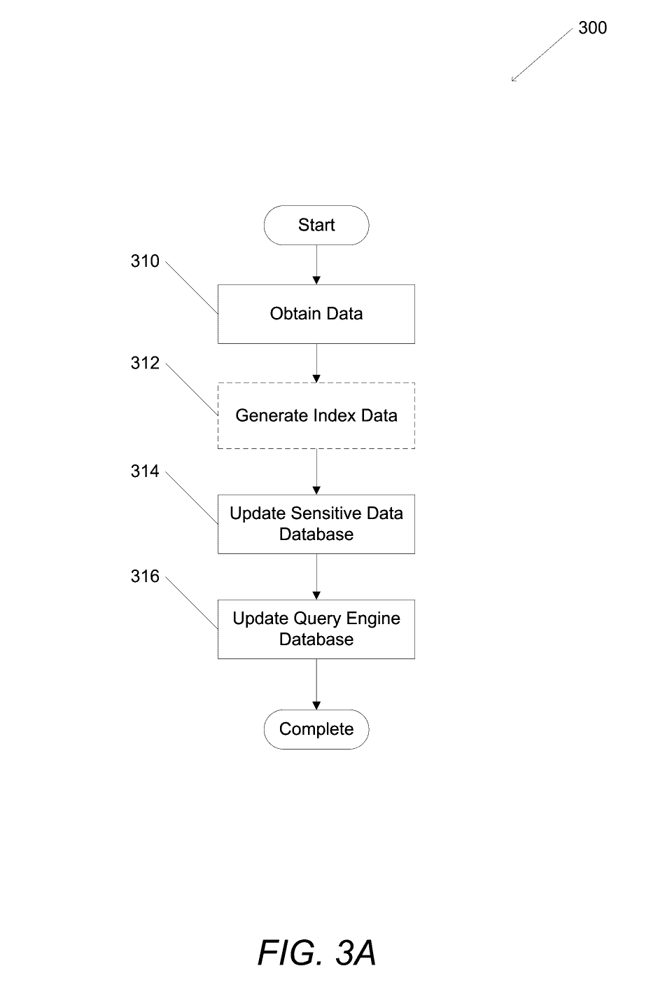

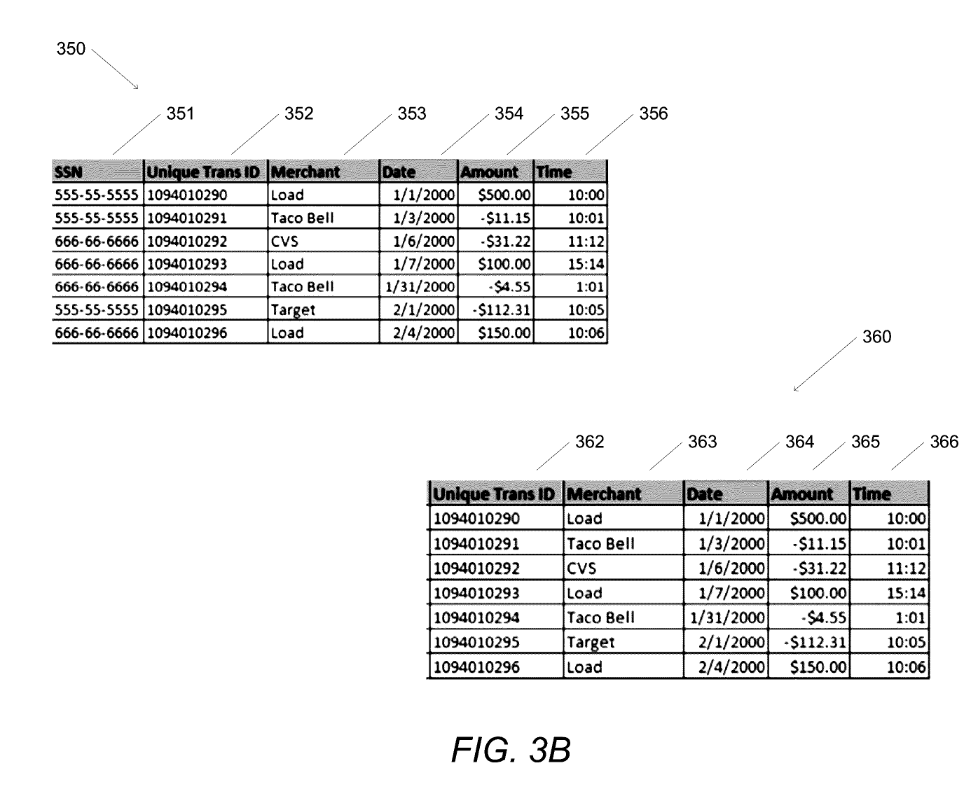

A process for storing data in accordance with embodiments of the invention is shown in FIG. 3A. The process 300 includes obtaining (310) data and, in many embodiments, generating (312) index data. A sensitive data database is updated (314) and a query engine database is updated (316).

Turning now to FIG. 3B, a conceptual illustration of data loaded into a sensitive data database and a query engine database is shown. The sensitive data database 350 includes a variety of pieces of transaction data including a variety of attribute/value pairs. The attributes of the transaction data include a social security number 351, transaction identification data 352, merchant data 353, date data 354, amount data 355, and time data 356. In the illustrated example, the social security number 351 is marked as sensitive data that is subject to access control and/or enhanced security measures. Accordingly, the social security number 351 is removed from the transaction data before it is loaded into the query engine database 360. The query engine database 360 includes a variety of pieces of transaction data including attribute/value pairs similar to those described with respect to the sensitive data database, including transaction identification data 362, merchant data 363, date data 364, amount data 365, and time data 366. As described herein, the query engine database can be utilized to provide non-sensitive data for further analysis and/or processing. In those instances where access to the sensitive social security number data is permitted, the transaction identification data 362 can be used to locate the corresponding transaction data stored in the sensitive data database 350 using the transaction identification data 352. Once the corresponding transaction data is located, the social security number 351 can be incorporated into the result data generated via the query engine database 360.

Specific processes for storing data in accordance with embodiments of the invention are described above; however, any of a variety of processes, including those that process and/or aggregate account data into one or more databases utilizing alternative techniques, can be utilized as appropriate to the requirements of specific applications in accordance with embodiments of the invention.

### Generating Query Engine Databases

As described above, a variety of account servicing processes include identifying and filtering sensitive data from a set of obtained data. In a variety of embodiments, the obtained data is formatted using a pre-defined format and the sensitive data can be identified based on the pre-defined format. In several embodiments, the obtained data is formatted using any of a variety of markup languages (such as XML or XBRL). The the tags associated with each piece of data can be utilized to identify the sensitive data within the obtained data. Additionally, metadata can be included in the obtained data that can be utilized to identify sensitive and/or non-sensitive data within the obtained data. Furthermore, the sensitive data may be encoded or otherwise encrypted while the non-sensitive data is provided in an unencrypted fashion.

In many embodiments, the format of the data within the obtained data can be utilized to identify sensitive data. For example, known patterns could be compared to the pieces of data to identify data conforming to known patterns of sensitive data. For example, social security numbers can be stored as nine consecutive digits or in the format ###-##-####. Similarly, a tax identification number (or an employer identification number) can be stored in the format ##-#######. Indeed, any formatting of a personal identification number can be utilized in accordance with the requirements of specific embodiments of the invention. By way of a second example, a prepaid card, credit card, or any other card can be identified by a primary account number (PAN). In many embodiments, a PAN is formatted as BBBBBBdddddddddC, where BBBBBB is a bank identification number (BIN), ddddddddd is the account number, and C is a check digit. In a number of embodiments, the check digit is determined is generated using a mathematical formula MOD 10 on the other fifteen digits in the PAN and can be utilized to verify that the PAN is valid. In a variety of embodiments, a PAN is formatted as TddddddddddddddC, where T is a type code. The type code can be utilized to identify the type of account being presented. However, any formatting of a primary account number can be utilized in accordance with the requirements of specific embodiments of the invention.

The sensitive data can be filtered from the obtained data, leaving behind the non-sensitive data. In several embodiments, the filtered data can be aggregated based on any of the attributes and/or values present in the data. The filtered and/or aggregated data can be stored using a query engine database.

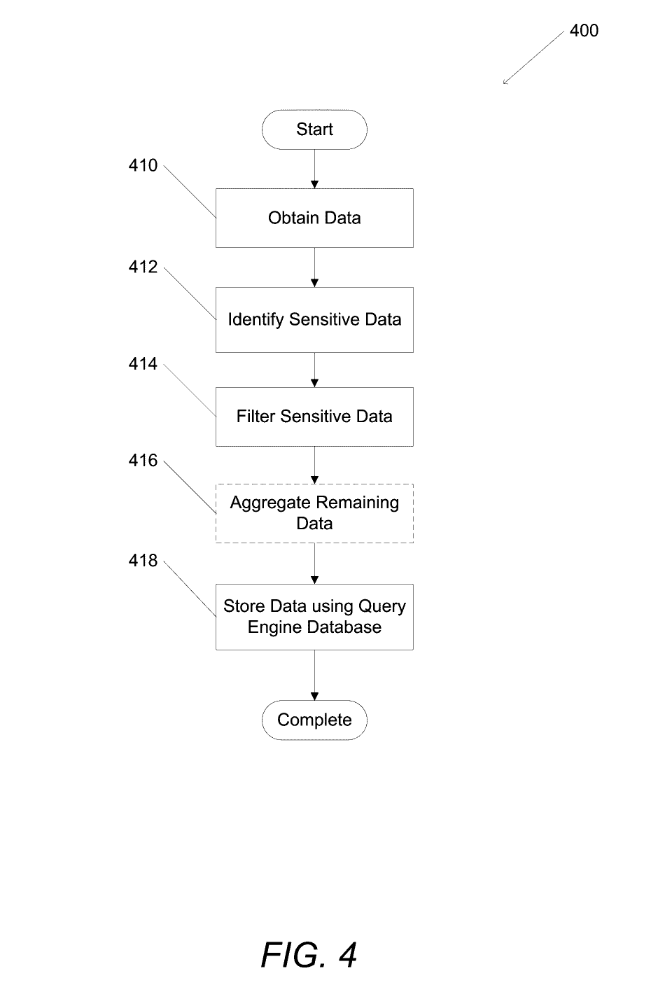

A process for generating query engine databases in accordance with embodiments of the invention is shown in FIG. 4. The process 400 includes obtaining (410) data, identifying (412) sensitive data, filtering (414) sensitive data, and, in a variety of embodiments, aggregating (416) data. Data is stored (418) using a query engine database.

Although specific processes for generating query engine databases in accordance with embodiments of the invention are described above, any of a variety of processes, including those that utilize indexing data that is generated in addition to the obtained data, can be utilized as appropriate to the requirements of specific applications in accordance with embodiments of the invention.

### Providing Result Data

Account servicing processes can also include providing data that has been stored in sensitive data databases and query engine databases. Query data describing the requested data can be obtained from any of a variety of systems, such as client devices. In a variety of embodiments, the query data identifies one or more attributes and/or values to be matched to data stored in a database. In several embodiments, the attributes and/or values available to be queried are defined based on the non-sensitive data stored using the query engine database. The query data can be any query, such as a SQL query or a MapReduce request, as appropriate to the requirements of specific applications of embodiments of the embodiments. In many embodiments, the query data is executed against a query engine database. The executed query causes a set of result data including non-sensitive data stored in the query engine database to be generated. In many embodiments, index data associated with (and/or included in) the result data generated from the query engine database can be utilized to identify sensitive data stored in a sensitive data database. In many embodiments, the index data is only included in the result data when sufficient permissions are associated with the query to access sensitive data. The result data can then be stored and/or provided as appropriate to the requirements of specific applications of embodiments of the invention.

In a number of embodiments, a query can identify one or more attributes or values corresponding to sensitive data. In several embodiments, a variety of security authorizations can be performed in order to determine if access to any sensitive data can be permitted. These security authorizations include utilizing access control lists to determine if a query is provided by a user and/or device capable of accessing sensitive data. In a variety of embodiments, security authorizations are based on the physical location of the device providing the query. In this way, only queries obtained from devices in known secured locations (for example, in a secure room or on a secure network) are capable of accessing the sensitive data database. The permissions granted can be general (that is, to the entire sensitive data database) and/or defined based on particular attributes and/or values within the stored data as appropriate to the requirements of specific applications of embodiments of the invention.

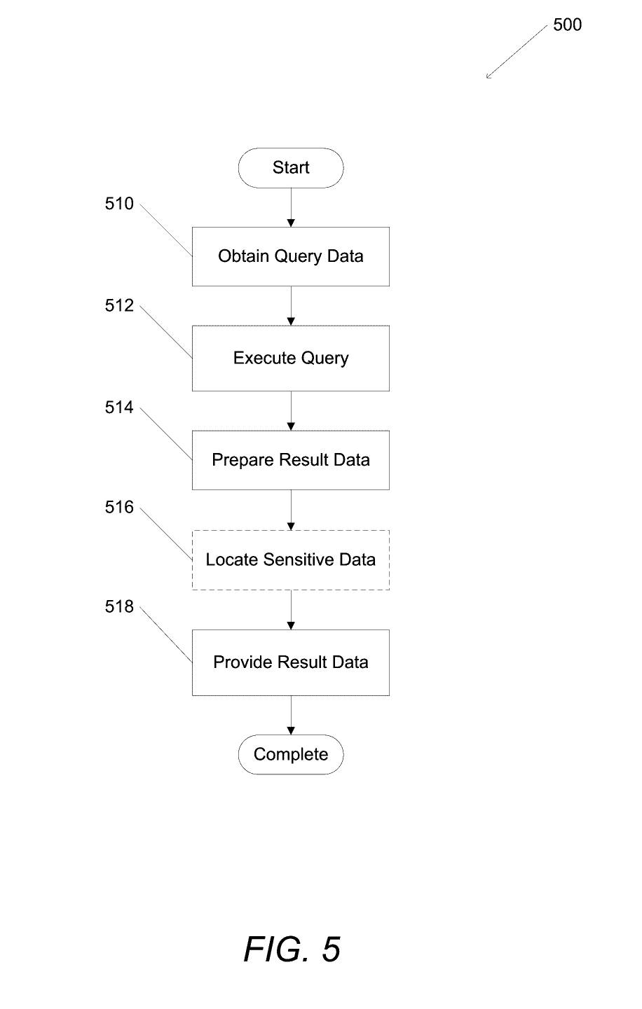

A process for providing result data in accordance with embodiments of the invention is shown in FIG. 5. The process 500 includes obtaining (510) query data, executing (512) a query, preparing (514) result data, and, in a number of embodiments, locating (516) sensitive data. Result data is provided (518).

Specific processes for providing result data in accordance with embodiments of the invention are described above; however, any of a variety of processes, including those that utilize alternative techniques for validating the use of sensitive data, can be utilized as appropriate to the requirements of specific applications in accordance with embodiments of the invention.

### Providing Sensitive Data

In many embodiments, an obtained query can include a request for sensitive data. Account servicing processes can include determining when sensitive data can be included in a set of result data and/or including the requested data. Query data can be obtained utilizing processes similar to those described above and used to generate result data containing non-sensitive data. Sensitive data associated with the non-sensitive data can be identified. In a variety of embodiments, attributes in the non-sensitive data having values in common with attributes in the sensitive data are used to identify corresponding data. In several embodiments, an index value is used to identify the corresponding sensitive and non-sensitive data. As described in more detail above, these index values can be automatically generated when the data is processed to be stored. In a number of embodiments, the sensitive data is decrypted and/or decoded. The identified sensitive data can be used to update the result data to include the appropriate sensitive data based on the obtained query and/or permissions data. The result data can be provided and/or stored as described above. In many embodiments, the result data can only be provided to client devices (or any other system) that is contained in a secured area. In this way, the risk associated with improperly disclosing sensitive data can be minimized.

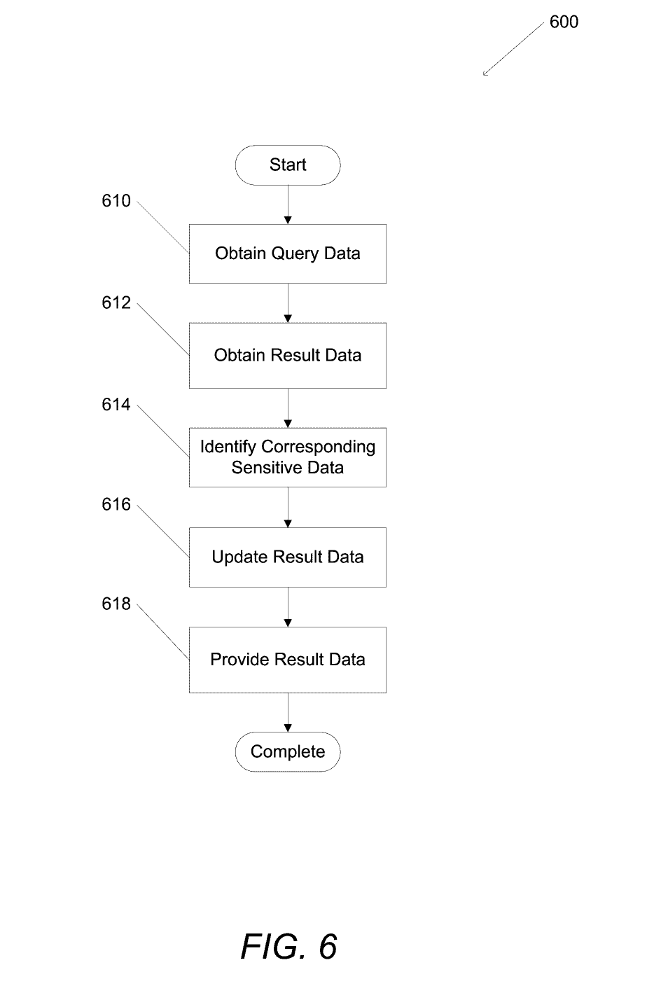

A process for authorizing transactions in accordance with embodiments of the invention is shown in FIG. 6. The process 600 includes obtaining (610) query data, obtaining (612) result data, identifying (614) corresponding sensitive data, updating (616) result data, and providing (618) result data.

Specific processes for providing sensitive data in accordance with embodiments of the invention are described above; however, any of a variety of processes, including those that utilize alternative techniques for identifying data present in the sensitive data database, can be utilized as appropriate to the requirements of specific applications in accordance with embodiments of the invention.

Although the present invention has been described in certain specific aspects, many additional modifications and variations would be apparent to those skilled in the art. In particular, any of the various processes described above can be performed in alternative sequences and/or in parallel (on the same or on different computing devices) in order to achieve similar results in a manner that is more appropriate to the requirements of a specific application. It is therefore to be understood that the present invention can be practiced otherwise than specifically described without departing from the scope and spirit of the present invention. Thus, embodiments of the present invention should be considered in all respects as illustrative and not restrictive. Accordingly, the scope of the invention should be determined not by the embodiments illustrated, but by the appended claims and their equivalents.

What is claimed is:

1. A method for storing data, comprising:
obtaining data using an account servicing server system, where the account servicing server system comprises:
a processor;
memory connected to the processor;
a sensitive data database; and
a query engine database;
identifying sensitive data in the obtained data using the account servicing server system, where the sensitive data comprises personally identifiable information;
identifying non-sensitive data in the obtained data using the account servicing server system;
storing the sensitive data in the sensitive data database using the account servicing server system; and
storing the non-sensitive data in the query engine database using the account servicing server system.

2. The method of claim 1, wherein the sensitive data database comprises a relational database management system.

3. The method of claim 1, wherein the query engine database comprises a distributed computing platform.

4. The method of claim 1, wherein the obtained data comprises transaction data comprising data selected from the group consisting of a transaction identifier, the amount of the transaction, the date of the transaction, the time of the transaction, the location at which the transaction was initiated, the payor account for the transaction, and the payee account for the transaction.

5. The method of claim 4, wherein the personally identifiable information in the transaction data is selected from the group consisting of the payor account for the transaction and the payee account for the transaction.

6. The method of claim 1, wherein the obtained data comprises account data comprising data selected from the group consisting of reload activity, balance activity, and location data, consumer account profile data, demographic data, employment information, credit status, income data, and mailing address data.

7. The method of claim 6, wherein the personally identifiable information in the account data is selected from the group consisting of the consumer account profile data, the employment information, and the mailing address data.

8. The method of claim 1, wherein the obtained data is obtained from a point of sale terminal located at a retailer.

9. The method of claim 1, wherein:
the obtained data comprises a set of attribute-value pairs formatted using the extensible business markup language; and
the sensitive data is identified based on the attributes present in the obtained data.

10. The method of claim 1,
the obtained data comprises a set of values; and
the sensitive data is identified based identifying known patterns in the set of values.

11. An account servicing server system, comprising:
a processor;
memory connected to the processor and storing an account servicing application;
a sensitive data database; and
a query engine database;
wherein the account servicing application directs the processor to:
obtain data;
identifying sensitive data in the obtained data, where the sensitive data comprises personally identifiable information;
identifying non-sensitive data in the obtained data;
storing the sensitive data in the sensitive data database; and
storing the non-sensitive data in the query engine database.

12. The system of claim 11, wherein the sensitive data database comprises a relational database management system.

13. The system of claim 11, wherein the query engine database comprises a distributed computing platform.

14. The system of claim 11, wherein the obtained data comprises transaction data comprising data selected from the group consisting of a transaction identifier, the amount of the transaction, the date of the transaction, the time of the transaction, the location at which the transaction was initiated, the payor account for the transaction, and the payee account for the transaction.

15. The system of claim 14, wherein the personally identifiable information in the transaction data is selected from the group consisting of the payor account for the transaction and the payee account for the transaction.

16. The system of claim 11, wherein the obtained data comprises account data comprising data selected from the group consisting of reload activity, balance activity, and location data, consumer account profile data, demographic data, employment information, credit status, income data, and mailing address data.

17. The system of claim 16, wherein the personally identifiable information in the account data is selected from the group consisting of the consumer account profile data, the employment information, and the mailing address data.

18. The system of claim 11, wherein the obtained data is obtained from a point of sale terminal located at a retailer.

19. The system of claim 11, wherein:
the obtained data comprises a set of attribute-value pairs formatted using the extensible business markup language; and
the sensitive data is identified based on the attributes present in the obtained data.

20. The system of claim 11,
the obtained data comprises a set of values; and
the sensitive data is identified based identifying known patterns in the set of values.
